(19) United States
(12) Patent Application Publication
(10) Pub. No.: US 2017/0316603 A1
(43) Pub. Date: Nov. 2, 2017

(54) VIRTUAL SYSTEM FOR SEEING A PROPERTY

(71) Applicant: WAN-LIN SUN, Changhua County (TW)

(72) Inventor: WAN-LIN SUN, Changhua County (TW)

(21) Appl. No.: 15/140,148

(22) Filed: Apr. 27, 2016

(51) Int. Cl. G06T 15/50; G06F 3/041; G06F 3/16; G06T 19/00

(52) U.S. Cl. CPC G06T 15/50; G06T 19/003; G06F 3/0412; G06F 3/16

(57) ABSTRACT

A virtual system for seeing a house includes an output module; a storage module for storing an outdoor view model and indoor view models wherein each indoor view model includes a passage open onto the outdoor; an input module; and a processing module for reading data from both the outdoor and indoor view models, disposing the indoor view models in the outdoor view model to switch an outdoor view screen to an indoor view screen for displaying on the output module or vice versa, updating at least one of the outdoor view screen and the indoor view screen, and moving at least one of the outdoor view screen and the indoor view screen through the passage. The virtual system enables an interested buyer to clearly see a house and fully understand both indoor and outdoor details of the house by not visiting the house in person.

### BACKGROUND OF THE INVENTION

### 1. Technical Field

The invention relates to systems for seeing a property and more particularly to a virtual system for enabling an interested buyer to see a house.

### 2. Related Art

The need to buy a property and/or renting an apartment is great due to population explosion. Technologies for enabling people to find a suitable property by not visiting it have been developed.

Early technology involves posting photographs of houses on a real estate website for viewing, i.e., the technology being a virtual system for enabling an interested buyer to see a house prior to buying. However, these photographs are two-dimensional (2D) plan views and unable to provide three-dimensional (3D) (i.e., perspective) views of houses for viewing. Thus, interested buyers cannot understand internal details of a house. A quick decision of buying the house by a potential buyer is not possible.

Recently, real estate agents used digital camera to take photographs in a house and posted the 3D video clips on the website for viewing. While such method has above advantages, but the 3D video clips have its limitations when playing. For example, it is played in a predetermined format and sequence, it cannot be rotated, and details of the house cannot be seen. Therefore, an interested buyer still cannot understand internal details of the house. Further, it is difficult of understanding whether people may collide when walking in the house by viewing the video clips. Furthermore, environment surrounding a property is also a factor affecting an individual's decision of buying the property or not. Therefore, information of the surrounding environment and location of the house in a city should be available. However, the typical technology of enabling people to see a property by not visiting it does not have above desired functions. Thus, the need for improvement still exists.

### BRIEF SUMMARY

It is therefore one object of the invention to provide a virtual system for seeing a property comprising an output module for presentation of images, text, video, and audio transmitted electronically; a storage module for storing an outdoor view model and a plurality of indoor view models wherein each indoor view model includes a passage open onto the outdoor; an input module for providing data and control signals to a predetermined apparatus; and a processing module for reading data from both the outdoor view model and the indoor view model, disposing the indoor view models in the outdoor view model to switch an outdoor view screen to an indoor view screen for display on the output module or vice versa, updating at least one of the outdoor view screen and the indoor view screen, and moving at least one of the outdoor view screen and the indoor view screen through the passage.

Preferably, the outdoor view model is an urban scene or a building.

Preferably, the outdoor view model is a plan view drawing depicting surrounding environment of the indoor view model.

Preferably, in the indoor view model a portion of the outdoor view model is shown through the passage.

Preferably, the storage module is a cloud storage.

Preferably, a virtual buyer is further stored in the storage module wherein the processing module is configured to read data from the storage module to access the virtual buyer, and the processing module is configured to move the virtual buyer to simulate a potential buyer who walks into a house to see interior of the house.

Preferably, the indoor view model includes at least one piece of furniture.

Preferably, a virtual light source is further provided for simulating sunlight or moonlight wherein the virtual light source is stored in the storage module, the processing module is configured to read data from the storage module to access the virtual light source, and the processing module is configured to move the virtual light source which is configured to emit light onto the outdoor view model, and the light is configured to illuminate the indoor view model through the passage.

Preferably, an audio databases is further stored in the storage module wherein the indoor view model is stored in one of a plurality of records of the audio database, the processing module is configured to read data from the storage module to access the indoor view model in the audio database with the indoor view screen being shown, and the processing module is configured to read audio data from the audio database, convert the data into an electrical audio signal, and convert the electrical audio signal into a corresponding sound.

Preferably, an audio databases is further stored in the storage module wherein the outdoor view model is stored in one of a plurality of records of the audio database, the processing module is configured to read data from the storage module to access the outdoor view model in the audio database with the outdoor view screen being shown, and the processing module is configured to read audio data from the audio database, convert the data into an electrical audio signal, and convert the electrical audio signal into a corresponding sound.

Preferably, the input module is a touch screen, a keyboard, a computer mouse, or an audio and video input device.

Preferably, the output module is a wearable device.

Preferably, each of the output module and the input module is a touch screen.

Preferably, a property database is further stored in the storage module wherein the processing module is configured to read data from the indoor view model and activate same, the processing module is configured to access the property database, and the accessed data is sent to the output module for display.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a virtual system for seeing a property according to a first preferred embodiment of the invention;

FIG. 2 is a top view of an outdoor view screen;

FIG. 3 is a detailed view of the area in a circle of FIG. 2;

FIG. 4 is a perspective view of an indoor view screen;

FIG. 5 is a block diagram of a virtual system for seeing a property according to a second preferred embodiment of the invention;

FIG. 6 is a top view of an outdoor view screen showing an operation thereof; and

FIG. 7 is a perspective view of an indoor view screen showing an operation thereof.

### DETAILED DESCRIPTION

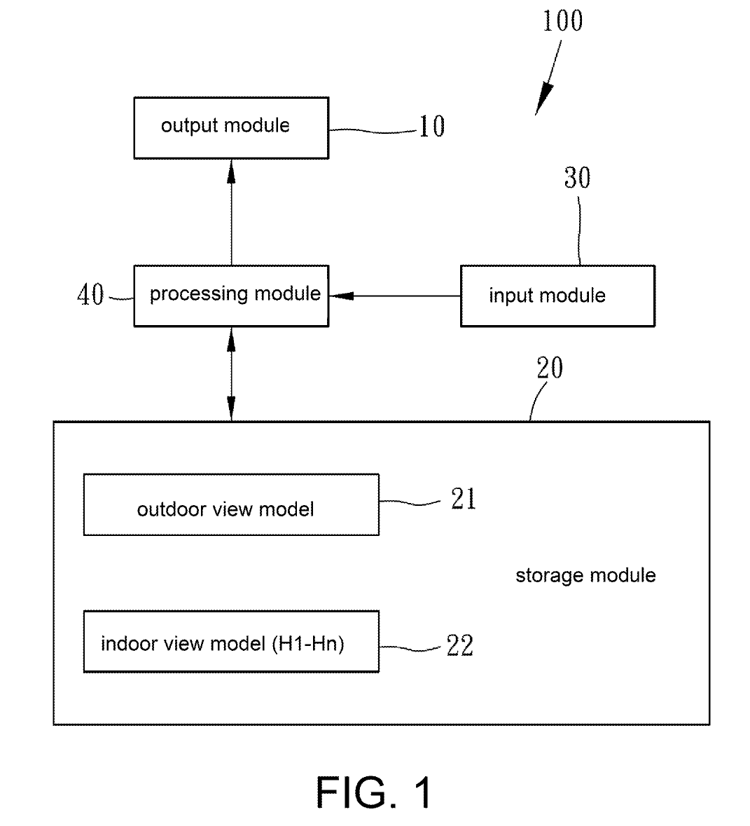

Referring to FIGS. 1 to 4, a virtual system 100 for enabling an interested buyer to see a house prior to buying in accordance with a first preferred embodiment of the invention comprises the following components as discussed in detail below.

An output module 10 is for presentation of images, text, video and audio transmitted electronically and it can be implemented as a liquid-crystal display (LCD) screen, a touch screen, or a wearable device such as an optical head-mount display.

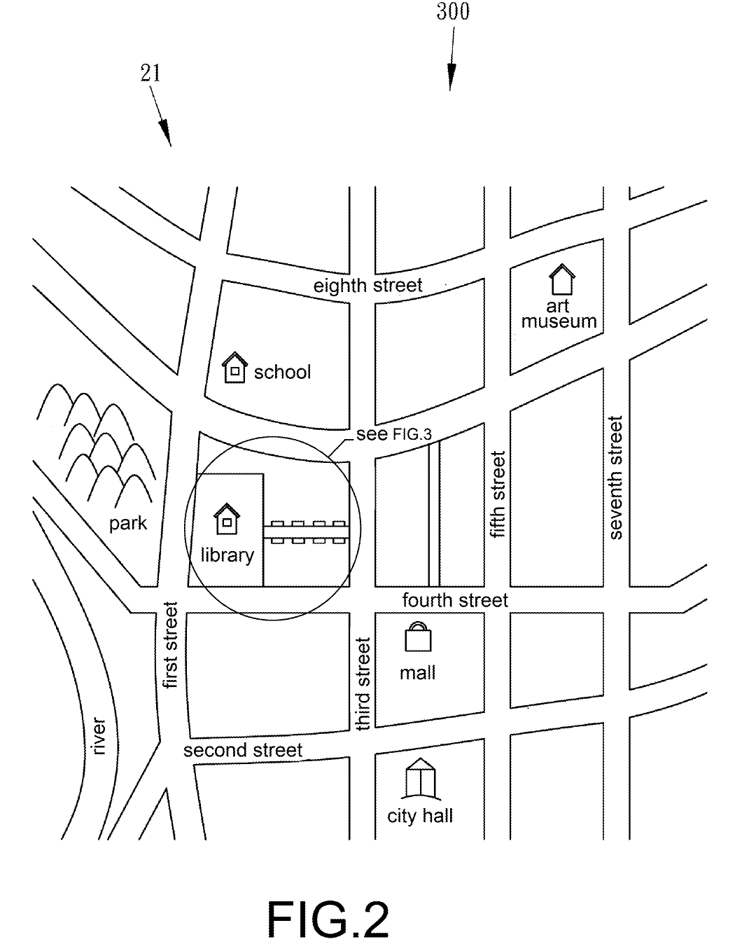

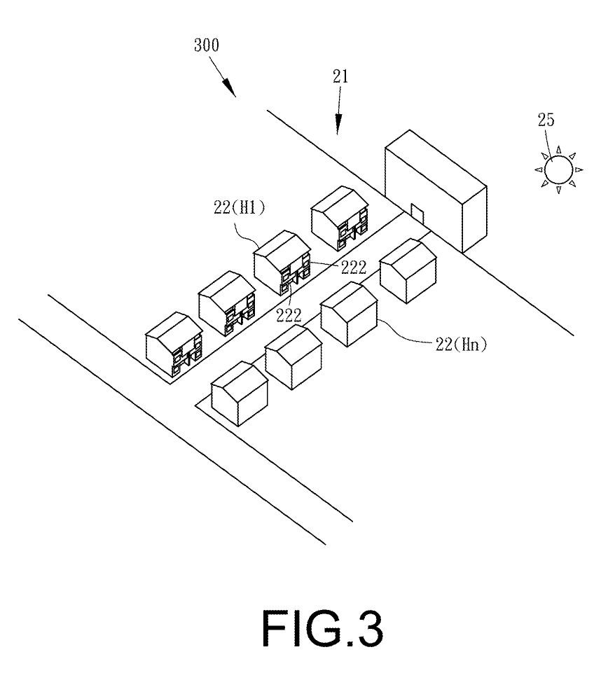

In the present embodiment, the compressed gas supplying device 30 is mainly used to provide the compressed gas which is needed by the seal detecting device of the present invention. The compressed gas supplying device 30 is linked to the gas supply side in the outer case 11 of the electronic device 10 inside the airtight container 20. In the present embodiment, the gas supply side is the outer side 14 in the outer case 11, and the inner side 13 of the outer case 11 is the detecting side. Since the gas supply side is full of compressed gas, and the detecting side is under normal atmosphere pressure, the gas pressure in the gas supply side is higher than that of the detecting side. In the present embodiment, a pipeline 73 is further provided to be connected to the compressed gas supplying device 30 and the gas supply side of the outer case 11 in the airtight container 20, which is also known as the outer side 14 of the outer case 11. A storage module 20 is used to store an outdoor view model 21 (see FIG. 2) and an indoor view model 22 (see FIG. 3). The outdoor view model 21 is capable of showing nature and architectures such as rivers, seas, mountains, trees, flowers, hills, buildings, roads, traffic facilities, governments, schools, malls and supermarkets. The outdoor view model 21 is a 3D model. Alternatively, the outdoor view model 21 is a 2D model surrounding the indoor view model 22. The indoor view model 22 is a 3D model and comprises a plurality of objects each labeled as one of H1 to Hn representing a house such as one of house 21(H1) to house 21(Hn) as shown in FIG. 3. The houses 21(H1) to 21(Hn) are stored in the storage module 20. As shown in FIG. 3, each indoor view model 22 has a passage 222 open onto the outdoor. Details such as rooms of a house and shapes of a house are contained in each indoor view model 22. Further, furniture items 221 and other household items are contained in each indoor view model 22. These elements are shown in photographs. The passage 222 can be replaced by a window or a door. The storage module 20 is implemented as a memory of a file server or cloud storage.

An input module 30 is an input device used to provide data and control signals to, for example, a computer. The input module 30 is implemented as a touch screen, a keyboard, a computer mouse, or an audio and video input device. The input module 30 can be incorporated into the output module 10 if the input module 30 is a touch screen. The control signals are used to, but not limited to, move a model or an object, move an individual, open a door, close a door, open a window, close a window, restrict conditions of a house, and select a desired house.

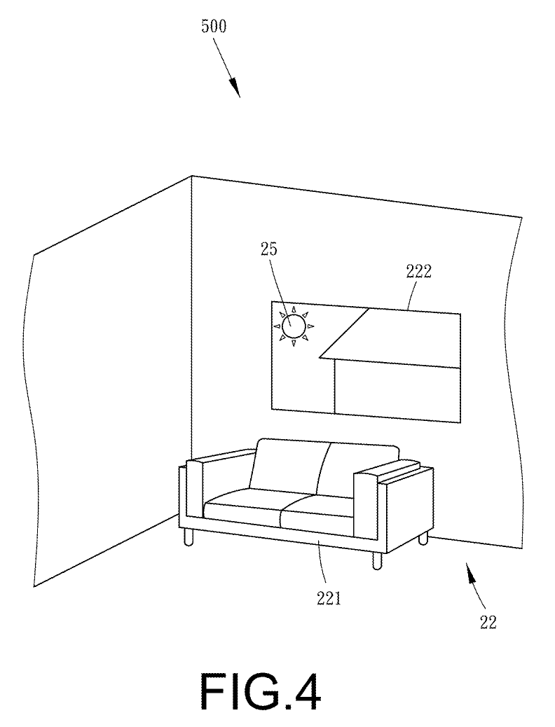

A processing module 40 is used to carry out instructions by performing the basic arithmetic, logical, control and input/output specified by the instructions. For example, the processing module 40 can read data from both the outdoor view model 21 and the indoor view model 22 and activate same, dispose the indoor view model 22 in the outdoor view model 21 to switch an outdoor view screen 300 (see FIG. 3) to an indoor view screen 500 (see FIG. 4) for displaying on the output module 100 or vice versa, update the outdoor view screen 300 and/or the indoor view screen 500, and move the outdoor view screen 300 and/or the indoor view screen 500 through the passage 222. For example, the outdoor view screen 300 may switch to the indoor view screen 500 via a window or vice versa.

As shown in FIG. 4, the indoor view model 22 is shown with an indoor view screen shown. A person in the house may see the sun 25 and outdoor scenes through the passage 222 which is implemented as a window. Each object in the indoor view model 22 can be rotated by executing computer instructions so that details of the desired object can be seen clearly.

A potential buyer may operate the input module 30 to input query terms. The processing module 40 may process the terms with respect to a chosen property such as the indoor view model 22 labeled H1 (i.e., house 22(H1)). Further, the processing module 40 may read data and process both the outdoor view model 21 and the indoor view model 22 with respect to the house 22(H1). As a result, the purpose of enabling an interested buyer to see a house by using the virtual system of the invention is obtained.

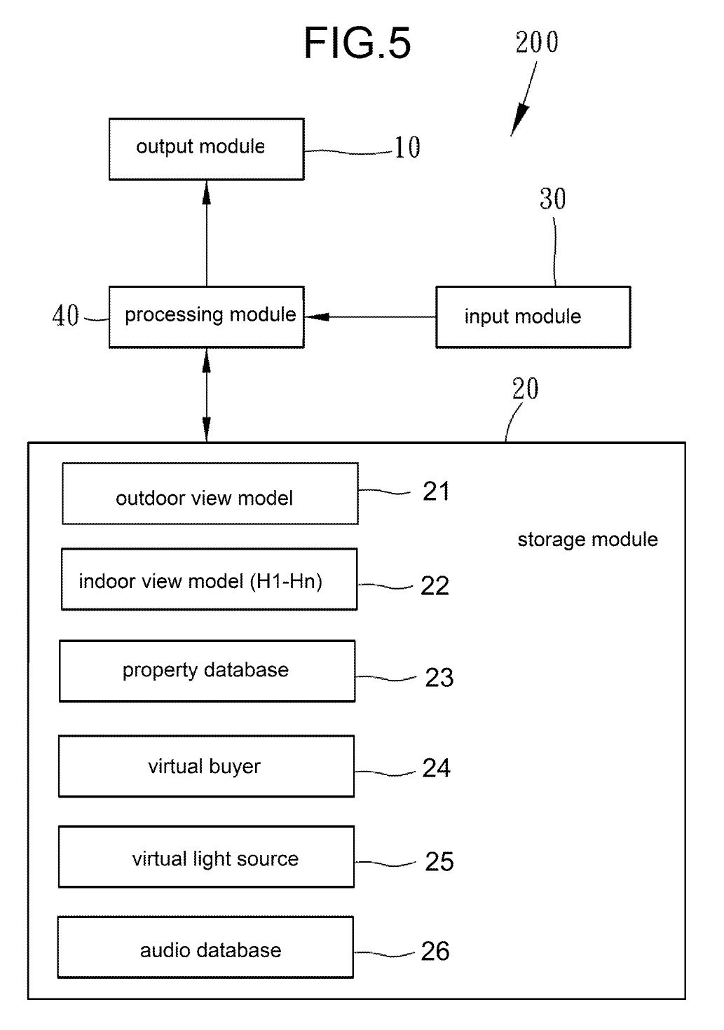

Referring to FIG. 5, a virtual system 200 for enabling an interested buyer to see a house prior to buying in accordance with a second preferred embodiment of the invention is shown. The characteristics of the second preferred embodiment are substantially the same as that of the first preferred embodiment except the following.

The storage module 20 further comprises a property database 23, a virtual buyer 24, a virtual light source 25, and an audio database 26. In detail, the property database 23 contains data including years, area, and conditions of a house, and surrounding environment such as parks, schools, governments, public facilities, rivers, lakes, etc. The processing module 40 may read data from the indoor view model 22 and activate same and at the same time the processing module 40 may access the property database 23. The accessed data is sent to the output module 10 for display.

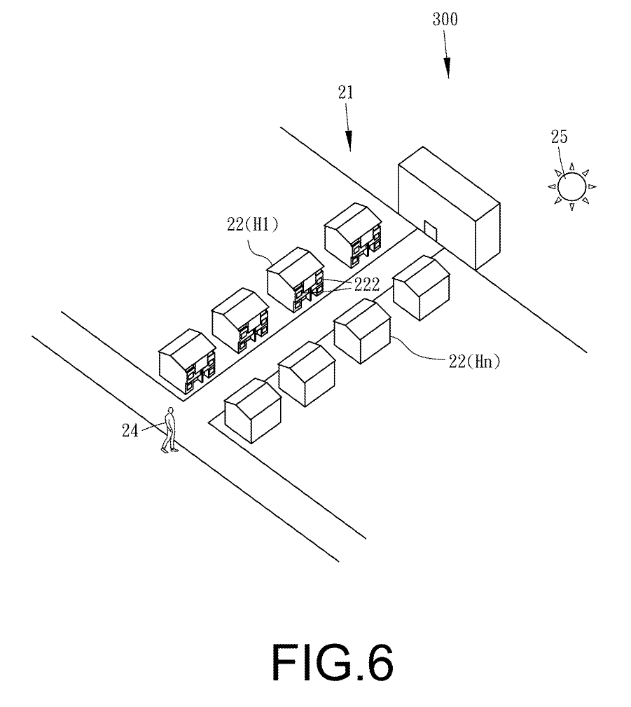

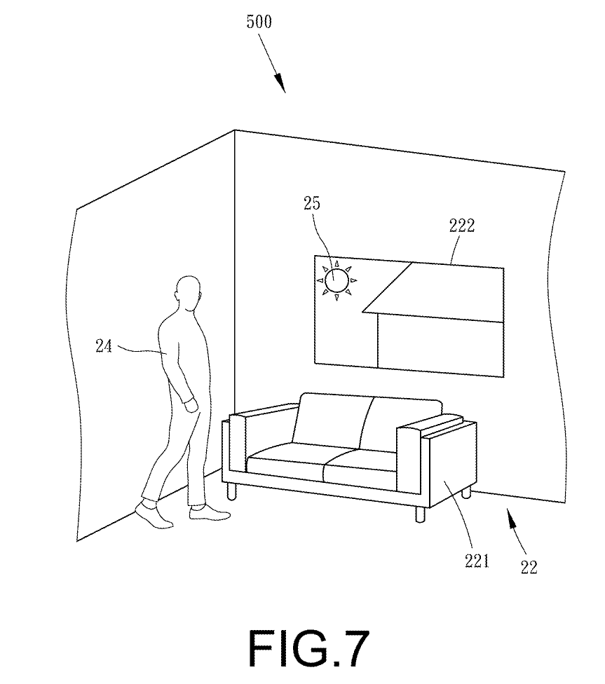

The virtual buyer 24 is stored in the storage module 20. The processing module 40 may read data from the storage module 20 to access the virtual buyer 24. And in turn, the processing module 40 may move the virtual buyer 24 to simulate a potential buyer who walks from a road into a house to see interior of the house as shown in FIGS. 6 and 7. In FIG. 7, the virtual buyer 24 may walk in the house to see interior thereof and the potential buyer may determine whether a piece of furniture 24 may interfere with a walking path or not by watching the movements of the virtual buyer 24. In FIG. 6, the virtual buyer 24 may walk on the street to see surrounding environment of the house 22(H1) or the house 22(Hn). The surrounding environment is constructed by the outdoor view model 21. The implementations shown in FIGS. 6 and 7 are very close to seeing a property by a potential buyer in person.

The virtual light source 25 is used to simulate sunlight or moonlight. The virtual light source 25 is stored in the storage module 20. The processing module 40 may read data from the storage module 20 to access the virtual light source 25. And in turn, the processing module 40 may move the virtual light source 25 which in turn may emit light onto the outdoor view model 21 (see FIG. 6). Alternatively, the light may illuminate the indoor view model 22 through the passage 222 (i.e., window) as shown in FIG. 7. It is envisaged by the invention that the virtual light source 25 may illuminate interior of a house 24 hours a day by simulating the sun or the moon. Therefore, a potential buyer may easily understand illumination within a house.

The audio database 26 is stored in the storage module 20. The indoor view model 22 is stored in one of records of the audio database 26 and the outdoor view model 21 is stored in another record of the audio database 26. The processing module 40 may read data from the storage module 20 to access the indoor view model 22 in the audio database 26. And in turn, the indoor view screen 500 is shown. Also, the processing module 40 reads audio data from the audio database 26 and converts the data into audio signals. The audio signals are presented in a form of audible introduction of years, area, and conditions of a house.

Similarly, the processing module 40 may read data from the storage module 20 to access the outdoor view model 21 in the audio database 26. And in turn, the outdoor view screen 300 is shown. Also, the processing module 40 reads audio data from the audio database 26 and converts the data into audio signals. The audio signals are presented in a form of audible introduction of surrounding environment such as roads, parks, schools, governments, public facilities, rivers, lakes, etc.

It is envisaged by the invention that the virtual system enables an interested buyer to clearly see a house and fully understand both indoor and outdoor details of the house by not visiting the house in person prior to making a correct choice of buying a house.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

1. A virtual system for enabling a potential buyer to see a house, comprising:
an output module for presentation of images, text, video, and audio transmitted electronically;
an outdoor view 3D model;
at least one indoor view 3D model including a passage open onto the outdoor view 3D model;
a storage module for storing the outdoor view 3D model and at least one indoor view 3D model;
an input module for providing data and control signals to a predetermined apparatus; and
a processing module for reading data from both the outdoor view 3D model and the indoor view 3D model, disposing the indoor view models in the outdoor view model to switch an outdoor view screen to an indoor view screen for displaying on the output module or vice versa, updating at least one of the outdoor view screen and the indoor view screen, and moving at least one of the outdoor view screen and the indoor view screen through the passage.

2. The virtual system of claim 1, wherein the outdoor view model is an urban scene or a building.

3. The virtual system of claim 1, wherein the outdoor view model is a plan view drawing depicting surrounding environment of the indoor view model.

4. The virtual system of claim 1, wherein in the indoor view model a portion of the outdoor view model is shown through the passage.

5. The virtual system of claim 1, wherein the storage module is a cloud storage.

6. The virtual system of claim 1, further comprising a virtual buyer stored in the storage module wherein the processing module is configured to read data from the storage module to access the virtual buyer, and the processing module is configured to receive control signals from the control module to move the virtual buyer to simulate a potential buyer who walks into a house to see interior of the house.

7. The virtual system of claim 1, wherein the indoor view model includes at least one piece of furniture.

8. The virtual system of claim 1, further comprising a virtual light source for simulating sunlight or moonlight wherein the virtual light source is stored in the storage module, the processing module is configured to read data from the storage module to access the virtual light source, and the processing module is configured to move the virtual light source which is configured to emit light onto the outdoor view model, and the light is configured to illuminate the indoor view model through the passage.

9. The virtual system of claim 1, further comprising an audio database stored in the storage module wherein the indoor view model is stored in one of a plurality of records of the audio database, the processing module is configured to read data from the storage module to access the indoor view model in the audio database with the indoor view screen being shown, and the processing module is configured to read audio data from the audio database, convert the data into an electrical audio signal, and convert the electrical audio signal into a corresponding sound.

10. The virtual system of claim 1, further comprising an audio database stored in the storage module wherein the outdoor view model is stored in one of a plurality of records of the audio database, the processing module is configured to read data from the storage module to access the outdoor view model in the audio database with the outdoor view screen being shown, and the processing module is configured to read audio data from the audio database, convert the data into an electrical audio signal, and convert the electrical audio signal into a corresponding sound.

11. The virtual system of claim 1, wherein the input module is a touch screen, a keyboard, a computer mouse, or an audio and video input device.

12. The virtual system of claim 1, wherein the output module is a wearable device.

13. The virtual system of claim 1, wherein each of the output module and the input module is a touch screen.

14. The virtual system of claim 1, further comprising a property database stored in the storage module wherein the processing module is configured to read data from the indoor view model and activate same, the processing module is configured to access the property database, and the accessed data is sent to the output module for display.
